(19) United States
(12) Patent Application Publication
(10) Pub. No.: US 2004/0205016 A1
(43) Pub. Date: Oct. 14, 2004

(54) System and method for purchasing products through bidding online

(76) Inventors: Sun-Chang Lin, Tu-Chen (TW); Shu-Ming Zhou, Shenzhen (CN); Jun Cai, Shenzhen (CN); Xiao-Li Hu, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/823,100

(22) Filed: Apr. 12, 2004

(30) Foreign Application Priority Data
Apr. 11, 2003 (TW) 92108302

(51) Int. Cl. G06F 17/60

(52) U.S. Cl. 705/37

(57) ABSTRACT

A system for purchasing products through bidding online includes an application server (13), a corporation website (12), a database (15), a plurality of client computers (10) and a plurality of supplier computers (17). The application server includes a supplier data management module (131) for maintaining basic information on suppliers and their products, and predetermining a plurality of selected suppliers according to information on products to be purchased; a price inquiring/quoting/price negotiating management module (132) for inquiring of prices, receiving quotations from selected suppliers, negotiating prices, and generating price-related records; an online bidding management module (133) for opening a bid, comparing bidding results to determine a winning supplier, and generating bid-related records; a contract management module (134) for signing and maintaining of procurement contracts. A method for purchasing products through bidding online is also disclosed.

### BACKGROUND OF THE INVENTION

1. Field of the Invention

The present invention relates to online procurement management systems and methods, and especially to an online procurement management system and method which can generate a winning supplier through bidding online.

2. Background of the Invention

Procurement is one of the most important functions in corporation management. Procurement efficiency directly affects the existing and development of a corporation. Products that can be purchased not only include tangible objects such as raw materials, machines, office commodities, but also include intangible objects such as technologies, and service. In the circumstances of economic globalization, more and more corporations are seeking efficient ways of procurement management in order to reduce operating costs, improve qualities of products and develop new technologies.

Traditionally, most of the procurement procedures are handled by human beings. Those man-handled operations are undoubtedly costly and time-consuming. With the development of computer science and network technology, online procurement methods which are based on the Internet are becoming more and more popular in corporations due to their low costs, simple processes, and providing end-to-end services. Online procurement methods electronically manage the whole procurement procedures, which fully embodies the value-added characteristics of electronic management.

The art of performing online procurement processes through utilizing computer and network is disclosed in patents such as U.S. Pat. No. 5,970,474 issued on Oct. 19, 1999 and entitled Electronic Procurement System and Method for Trading Partners. This patent discloses an electronic business system comprising three hardware configurations: a corporation server, a supplier sever and an electronic trade management system. The electronic business system allows users of a purchasing organization to access the corporation server through an intranet to transmit information on products to be purchased, and access the supplier server through the Internet to trade online with the corresponding supplier. However, the patent only describes a system of trading between a purchasing organization and a supplier through a connection of an information system, and doesn't disclose skills of purchasing products through bidding online.

CN Patent No. 1,373,436A issued on Oct. 9, 2002 and entitled Method and System for Performing Online Procurement by Computer provides a supplier trade system for a purchasing organization and a plurality of suppliers to perform online procurement operations. The supplier trade system comprises a quotation management system, a product trade management system, a price enquiry management system and an order search management system. However, the system does not predetermine a plurality of suitable suppliers, so all suppliers that provide the product to be purchased can participate in online bidding activities, which results in complicated procurement processes and low procurement efficiency.

Accordingly, what is needed is to provide a system and method for purchasing products through bidding online, which can select a plurality of suitable suppliers in advance to participate in online bidding activities in order to simplify procurement processes and improve procurement efficiency.

### SUMMARY OF THE INVENTION

A main objective of the present invention is to provide a system and method for purchasing products through bidding online, which can predetermine a plurality of suitable suppliers according to information on products to be purchased and basic data on suppliers, receive bidding results from the selected suppliers, and compare bidding results to select a winning supplier.

To accomplish the above objective, a system for purchasing products through bidding online in accordance with a preferred embodiment of the present invention comprises an application server for maintaining basic data on products and suppliers, performing operations such as inquiring of prices, receiving quotations from selected suppliers and negotiating prices, managing procurement contracts, and calculating accounts after receiving purchased products; a corporation website connected to the application server for providing an operating platform for procurement transactions through bidding online; a plurality of client computers, each providing an interactive user interface for users of a purchasing organization to log on the corporation website to manage online bidding operations; a database for storing various information used or generated in online bidding procurement processes; and a plurality of supplier computers, each providing an interactive user interface for user of a corresponding supplier to perform online bidding operations.

The application server comprises: a procurement data management module for maintaining information on products to be purchased for a purchasing organization; a supplier data management module for maintaining basic information on suppliers and their products, and for selecting a plurality of suitable suppliers according to information on products to be purchased; a price inquiring/quoting/price negotiating management module for inquiring of prices, receiving quotations from selected suppliers, negotiating prices, and generating price-related records; an online bidding management module for opening a bid, comparing bidding results according to price-related records, determining a winning supplier, granting a winning bid to the winning supplier, and generating bid-related records; a contract management module for signing procurement contracts with winning suppliers online, and maintaining the procurement contracts; a stock receiving and accounts balancing module for receiving and checking of products delivered by winning suppliers according to information on products to be purchased.

Further, the present invention provides a method for purchasing products through bidding online, the method comprising the steps of: (1) receiving information on products to be purchased; (2) accessing basic data on corresponding suppliers that provide the products to be purchased, and selecting a plurality of suitable suppliers by comparing the information on the products to be purchased and the basic data on suppliers; (3) opening a bid online; (4) receiving bidding results from the selected suppliers; (5) comparing the bidding results to select a winning supplier; (6) granting a winning bid to the winning supplier, and notifying the winning supplier to deliver the products; (7) signing a procurement contract with the winning supplier; (8) checking the products delivered by the winning supplier according to the information on the products to be purchased and determining whether the quality of the products is satisfactory; and (9) calculating corresponding accounts if the quality of the products is satisfactory.

Other objects, advantages and novel features of the present invention will be drawn from the following detailed description of the preferred embodiment and preferred methods of the present invention with the attached drawings, in which:

### BRIEF DESCRIPTION OF THE DRAWINGS

FIG. 1 is a schematic diagram of hardware configuration of a system for purchasing products through bidding online in accordance with a preferred embodiment of the present invention;

FIG. 2 is a schematic diagram of main software function modules of the application server of FIG. 1;

FIG. 3a is a schematic diagram of main function units of a price inquiring/quoting/price negotiating management module of the application server;

FIG. 3b is a schematic diagram of main function units of an online bidding management module of the application server; and

FIG. 4 is a flowchart of a preferred method for purchasing products by bidding online according to the present invention.

### DETAILED DESCRIPTION OF THE INVENTION

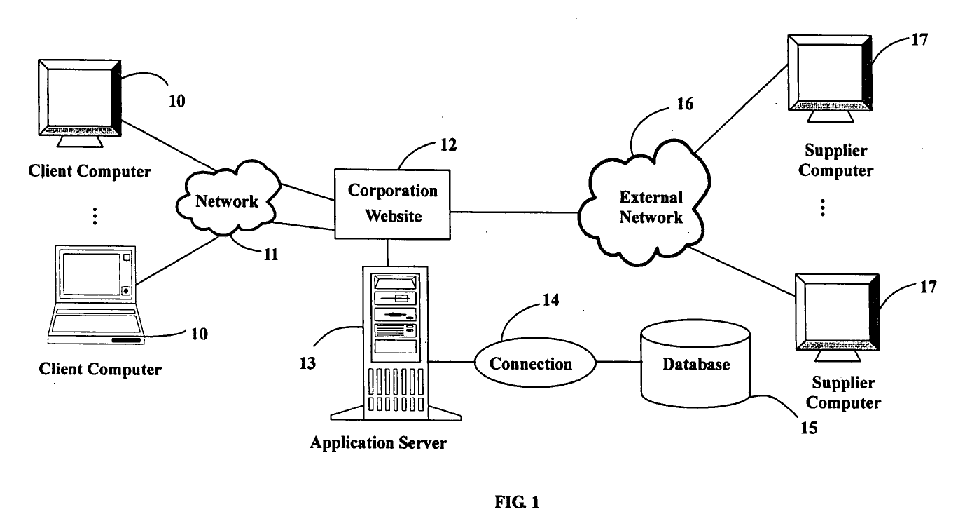

FIG. 1 is a schematic diagram of hardware configuration of a system for purchasing products through bidding online in accordance with the preferred embodiment of the present invention. The system comprises a plurality of client computers 10, a corporation website 12, an application server 13, a database 15, and a plurality of supplier computers 17. Each client computer 10 provides an interactive user interface for users of a purchasing organization logging on the corporation website 12 to manage online bidding operations. The corporation website 12 is connected to the application server 13, and provides an operating platform for purchasing products through bidding online. The application server 13 comprises a plurality of software function modules for maintaining basic data on products and suppliers, carrying out operations such as inquiring of prices, quoting and negotiating prices, managing online bidding activities, maintaining procurement contracts, and calculating corresponding accounts after accepting purchased products. The database 15 stores various information used or generated in online bidding procurement processes. The information includes information on products to be purchased, basic data on suppliers and their products, price-related records, and bid-related records. Each supplier computer 17 provides an interactive user interface for users of a corresponding supplier to perform online bidding operations.

The client computers 10 are connected to the corporation website 12 through a network 11. The network 11 may be an intranet, the Internet or any other suitable type of communication network. The application server 13 is connected to the database 15 through a connection 14, which is database connectivity such as Open Database Connectivity (ODBC) or Java Database Connectivity (JDBC). The corporation website 12 is connected to the supplier computers 17 through an external network 16, which can be the Internet.

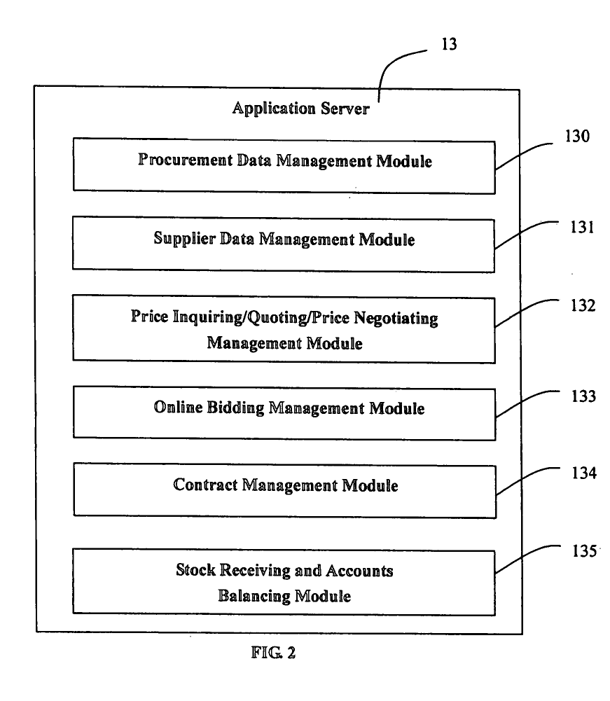

FIG. 2 is a schematic diagram of main software function modules of the application server 13. The application server 13 comprises a procurement data management module 130, a supplier data management module 131, a price inquiring/quoting/price negotiating management module 132, an online bidding management module 133, a contract management module 134, and a stock receiving and accounts balancing module 135.

The procurement data management module 130 maintains information on products to be purchased for the purchasing organization. Information on products to be purchased includes types, quantities, quality requirements and delivery dates of the products. The maintaining operations include adding, deleting, modifying and searching the information on products to be purchased. The supplier data management module 131 is for maintaining basic information on suppliers and their products, and for selecting a plurality of suitable suppliers according to information on products to be purchased. Information on suppliers includes names, telephone numbers and addresses of the suppliers. Information on products of a supplier includes names, specifications, and prices of the products. The price inquiring/quoting/price negotiating management module 132 is for inquiring of prices, receiving quotations from selected suppliers, negotiating prices, and generating price-related records. The online bidding management module 133 is for opening a bid, comparing bidding results according to price-related records, determining a winning supplier and granting a winning bid to the winning supplier, and generating bid-related records. The contract management module 134 is for signing procurement contracts with winning suppliers online, and for maintaining the procurement contracts. The stock receiving and accounts balancing module 135 is used for receiving and checking of products delivered by a winning supplier according to information on products to be purchased, and for accepting the products and calculating corresponding accounts if a quality of the products is satisfactory.

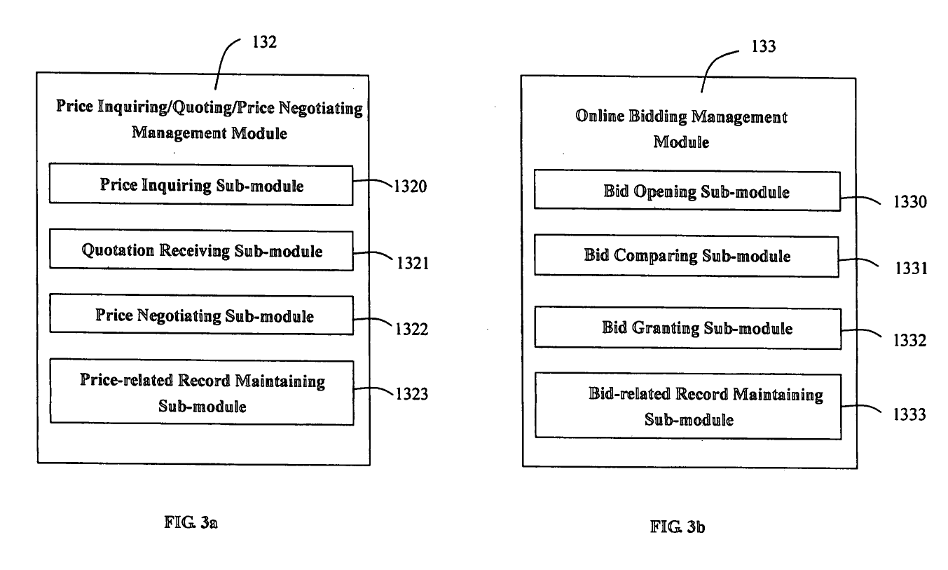

FIG. 3a is a schematic diagram of main function units of the price inquiring/quoting/price negotiating management module 132 of the application server 13. The price inquiring/quoting/price negotiating management module 132 comprises a price inquiring sub-module 1320, a quotation receiving sub-module 1321, a price negotiating sub-module 1322, and a price-related record maintaining sub-module 1323.

The price inquiring sub-module 1320 is for inquiring of prices of selected suppliers, and generating price inquiring records. The quotation receiving sub-module 1321 is for receiving quotations provided by the inquired suppliers, and generating quoting records. The price negotiating sub-module 1322 is for negotiating prices with selected suppliers, and generating price negotiating records. The price-related record maintaining sub-module 1323 is for adding, deleting, and checking price-related records. The price-related records are stored in the database 15, and comprise price inquiring records, quoting records and price negotiating records.

FIG. 3b is a schematic diagram of main function units of the online bidding management module 133 of the application server 13. The online bidding management module 133 comprises a bid opening sub-module 1330, a bid comparing sub-module 1331, a bid granting sub-module 1332, and a bid-related record maintaining sub-module 1333.

The bid opening sub-module 1330 is for opening a bid for selected suppliers logging on the corporation website 12 to bid online, and generating a bid opening record. The bid opening record comprises information on products to be purchased, a bid opening date, and the selected suppliers involved. The bid comparing sub-module 1331 is for selecting a winning supplier according to quoting records, price negotiating records and information on products to be purchased, and for generating a bid comparing record. The bid comparing record comprises a method for comparing bidding results, and for obtaining a result of the comparison. The bid granting sub-module 1332 is for granting a winning bid to a winning supplier, and generating a bid granting record. The bid granting record includes a name of the winning supplier, a time that the bid is granted, and a reply from the winning supplier. The bidding record maintaining sub-module 1333 is for adding, deleting, modifying and searching bid-related records. The bid-related records are stored in the database 15, and comprise bid opening records, bid comparing records and bid granting records.

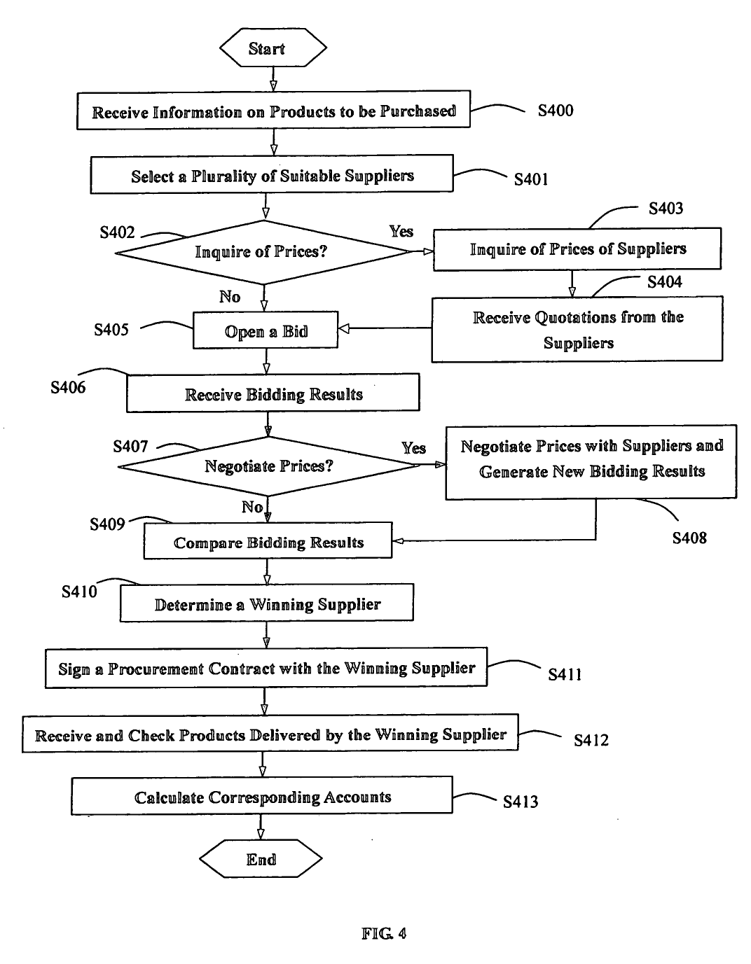

FIG. 4 is a flowchart of a preferred method for purchasing products by bidding online according to the present invention. In step S400, the procurement data management module 130 receives information on products to be purchased sent from one client computer 10, and stores said information in the database 15. In step S401, the supplier data management module 131 accesses basic data on corresponding suppliers that provide the products to be purchased, and selects a plurality of suitable suppliers by comparing the information on the products to be purchased and the basic data on the suppliers. In step S402, the price inquiring/quoting/price negotiating management module 132 determines whether there is price information in the basic data of each selected supplier. If no price information exists in the basic data of any selected supplier, the procedure goes to step S403 in order to inquire of a price of any such selected supplier. If there is price information in the basic data of all the selected suppliers, the procedure goes directly to step S405 described below.

In step S403, the price inquiring sub-module 1320 transfers price inquiring data to the corresponding supplier computers 17 through the external network 16. In step S404, the inquired suppliers receive the price inquiring data, and provide their respective quotations by logging on the corporation website 12. The quotation receiving sub-module 1321 accesses the quotations from the corporation website 12, generates quoting records, and stores the quoting records in the database 15.

In step S405, the bid opening sub-module 1330 opens a bid, generates a bid opening record, and stores the bid opening record in the database 15. In step S406, the bid opening sub-module 1330 receives bidding results from the selected suppliers. In step S407, the purchasing organization determines whether there is need to negotiate prices with any supplier according to the bidding results. If there is no need to negotiate prices with any supplier, the procedure goes directly to step S409 described below.

If there is a need to negotiate prices with any supplier, in step S408, the price negotiating sub-module 1322 receives price negotiating data from relevant client computers 10. The price negotiating data are then transferred to one or more relevant supplier computers 17 through the external network 16. The relevant suppliers reply to the price negotiating data, and offer renewed quotations by logging on the corporation website 12. The price negotiating sub-module 1322 accesses the renewed quotations from the corporation website 12, generates new bidding results, and stores the new bidding results in the database 15.

In step S409, the bid comparing sub-module 1331 directly compares the bidding results. First, the purchasing organization determines a method for comparing the bidding results. The method may be comparing the bidding results only according to prices offered by the selected suppliers, or may involve considering prices and product qualities in combination. Then, by applying the determined method, the bid comparing sub-module 1331 selects a winning supplier according to the quoting records, the price negotiating records and the information on products to be purchased, generates a bid comparing record, and stores the bid comparing record in the database 15. In step S410, the bid granting sub-module 1332 checks the bid comparing record, and grants a winning bid to the winning supplier through the external network 16. The grant of the bid includes notification to the winning supplier to deliver the products. The winning supplier replies to the grant by logging on the corporation website 12. If the winning supplier does not accept the grant, the bid comparing sub-module 1331 compares the bidding results of the other selected suppliers, and selects a new winning supplier. The above-described procedure is repeated as necessary until a winning supplier accepts a grant. In step S411, the purchasing organization signs a procurement contract with the winning supplier through the contract management module 134. In step S412, the stock receiving and accounts balancing module 135 receives the information on the products to be purchased from said one client computer 10, and the products delivered by the winning supplier are checked according to said information. If the quality of the products delivered by the winning supplier is not satisfactory, the stock receiving and accounts balancing module 135 notifies the winning supplier through the external network 16 either that the products must be re-delivered or that the products will be returned without further dealing. If the products are returned without further dealing, the online bidding management module 133 selects a new winning supplier from the other selected suppliers, and the above-described procedure is repeated as necessary until a winning supplier delivers products of satisfactory quality. If the quality of the products delivered by the winning supplier is satisfactory, in step S413, the stock receiving and accounts balancing module 135 calculates corresponding accounts for the products.

Although the present invention has been specifically described on the basis of a preferred embodiment and preferred method, the invention is not to be construed as being limited thereto. Various changes or modifications may be made to said embodiment and methods without departing from the scope and spirit of the invention.

What is claimed is:

1. A system for purchasing products through bidding online, the system comprising a corporation website, an application server, a database linking to the application server through a connection, a plurality of client computers linking to the corporation website through a network, and a plurality of supplier computers linking to the corporation website through an external network, wherein the application server comprises:
a supplier data management module for maintaining basic information on suppliers and their products, and for selecting a plurality of suitable suppliers according to information on products to be purchased;
a price inquiring/quoting/price negotiating management module for inquiring of prices, receiving quotations from selected suppliers, negotiating prices, and generating price-related records;
an online bidding management module for opening a bid, comparing bidding results according to price-related records, determining a winning supplier, granting a winning bid to the winning supplier, and generating bid-related records; and
a contract management module for signing procurement contracts with winning suppliers online, and for maintaining the procurement contracts.

2. The system according to claim 1, wherein the application server further comprises a procurement data management module for maintaining information on products to be purchased for a purchasing organization.

3. The system according to claim 1, wherein the application server further comprises a stock receiving and accounts balancing module for receiving and checking of products delivered by a winning supplier according to information on products to be purchased.

4. The system according to claim 1, wherein the price inquiring/quoting/price negotiating management module comprises:
a price inquiring sub-module for inquiring of prices of selected suppliers, and generating price inquiring records;
a quotation receiving sub-module for receiving quotations provided by inquired suppliers, and generating quoting records;
a price negotiating sub-module for negotiating prices with suppliers, and generating price negotiating records; and
a price-related record maintaining sub-module for adding, deleting and checking price-related records, said price-related records comprising price inquiring records, quoting records and price negotiating records.

5. The system according to claim 1, wherein the online bidding management module comprises:
a bid opening sub-module for opening a bid for selected suppliers logging on the corporation website to bid online, and generating a bid opening record;
a bid comparing sub-module for selecting a winning supplier according to quoting records, price negotiating records and information on products to be purchased, and for generating a bid comparing record;
a bid granting sub-module for granting a winning bid to a winning supplier, and generating a bid granting record; and
a bidding record maintaining sub-module for adding, deleting, modifying and searching bid-related records, said bid-related records comprising bid opening records, bid comparing records and bid granting records.

6. A method for purchasing products through bidding online, the method comprising the steps of:
receiving information on products to be purchased;
accessing basic data on corresponding suppliers that provide the products to be purchased, and selecting a plurality of suitable suppliers by comparing the information on the products to be purchased and the basic data on suppliers;
opening a bid online;
receiving bidding results from the selected suppliers;
comparing the bidding results to select a winning supplier; and
granting a winning bid to the winning supplier and notifying the winning supplier to deliver the products.

7. The method according to claim 6, further comprising the steps of:
signing a procurement contract with the winning supplier through the contract management module;
checking the products delivered by the winning supplier according to the information on the products to be purchased, and determining whether the quality of the products is satisfactory; and
calculating corresponding accounts if the quality of the products is satisfactory.

8. The method according to claim 6, wherein the step of opening a bid online comprises the steps of:
determining whether there is price information in the basic data on each of the selected suppliers;
inquiring of a price of a selected supplier if there is no price information in the basic data on that selected supplier; and
opening a bid online, generating a bid opening record and storing the bid opening record in a database, if and when there is price information in the basic data on all the selected suppliers.

9. The method according to claim 6, wherein the step of comparing the bidding results comprises the steps of:
determining whether there is need to negotiate price with any of the selected suppliers according to the bidding results;
negotiating price with one or more of the selected suppliers and generating one or more new bidding results, if price negotiating is needed; and
comparing the bidding results to select a winning supplier according to the quoting records, the price negotiating records and the information on the products to be purchased, generating a bid comparing record, and storing the bid comparing record in the database.

10. The method according to claim 6, wherein the step of granting a winning bid to the winning supplier comprises the step of comparing the other selected suppliers and selecting a new winning supplier if the winning supplier does not accept the grant.

11. The method according to claim 7, wherein the step of checking the products delivered by the winning supplier further comprises the step of notifying the winning supplier that the products must be re-delivered or that the products will be returned, if the quality of the products delivered is not satisfactory.
